(19) United States
(12) Patent Application Publication
(10) Pub. No.: US 2026/0285631 A1
(43) Pub. Date: Sep. 24, 2026

(54) PAPER TRANSPORT APPARATUS

(71) Applicant: FUJIFILM Business Innovation Corp., Tokyo (JP)

(72) Inventors: Toshitaka TANAKA, Kanagawa (JP); Toshio KONDO, Kanagawa (JP); Hiroyuki MOMIYAMA, Kanagawa (JP); Ryuga OISHI, Kanagawa (JP)

(73) Assignee: FUJIFILM Business Innovation Corp., Tokyo (JP)

(21) Appl. No.: 19/262,104

(22) Filed: Jul. 8, 2025

(30) Foreign Application Priority Data
Mar. 24, 2025 (JP) 2025-049113

(51) Int. Cl. G03G 15/00

(52) U.S. Cl. CPC G03G 15/6567

(57) ABSTRACT

A paper transport apparatus includes an abutting portion against which a leading end of paper being transported is abutted and that corrects a slant of the paper, a drive unit that includes a motor which reciprocates the abutting portion between a standby position where the abutting portion waits for the paper and a retreated position where the abutting portion is retreated from a transport path on a downstream side of the standby position in a transport direction, and a release mechanism that releases transmission of a drive force from the motor to the abutting portion during movement of the abutting portion to the standby position.

### CROSS-REFERENCE TO RELATED APPLICATIONS

This application is based on and claims priority under 35 USC 119 from Japanese Patent Application No. 2025-049113 filed Mar. 24, 2025.

### BACKGROUND

### (i) Technical Field

The present invention relates to a paper transport apparatus.

### (ii) Related Art

JP2012-254847A below describes a paper transport apparatus including an abutting portion against which paper being transported is abutted and that corrects skew of the paper.

In the paper transport apparatus, a carriage holding the abutting portion is driven by a motor. Accordingly, the abutting portion reciprocates between a standby position where the abutting portion waits for the paper and a retreated position where the abutting portion is retreated from the paper transport path.

### SUMMARY

Aspects of non-limiting embodiments of the present disclosure relate to a paper transport apparatus that returns an abutting portion to a standby position earlier compared to a case of decelerating the abutting portion through drive control of a motor.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present invention, there is provided a paper transport apparatus including an abutting portion against which a leading end of paper being transported is abutted and that corrects a slant of the paper, a drive unit that includes a motor which reciprocates the abutting portion between a standby position where the abutting portion waits for the paper and a retreated position where the abutting portion is retreated from a transport path on a downstream side of the standby position in a transport direction, and a release mechanism that releases transmission of a drive force from the motor to the abutting portion during movement of the abutting portion to the standby position.

### BRIEF DESCRIPTION OF THE DRAWINGS

Exemplary embodiment(s) of the present invention will be described in detail based on the following figures, wherein:

FIG. 1 is a side view of an example of a paper transport apparatus according to an exemplary embodiment of the present disclosure from a front side;

FIG. 2 is a perspective view showing a reversing mechanism in the paper transport apparatus;

FIG. 3 is a side view showing a peripheral structure of an abutting portion in the paper transport apparatus;

FIG. 4 is a plan view showing the peripheral structure of the abutting portion in the paper transport apparatus;

FIG. 5A is a side view showing a state where a carriage including the abutting portion starts to move to a downstream side in a paper transport direction;

FIG. 5B is a side view showing a state where the carriage moves to the downstream side in the paper transport direction;

FIG. 5C is a side view showing a state where the carriage moves to an upstream side in the paper transport direction;

FIG. 6A is a side view showing a state where the abutting portion is disposed at a standby position;

FIG. 6B is a side view showing a state where a leading end portion of paper is abutted against the abutting portion and skew correction is performed.

FIG. 6C is a side view showing a state where the paper is continuously transported in a state where the leading end portion of the paper abuts against the abutting portion;

FIG. 6D is a side view showing a state where the abutting portion has reached a place beyond a second transport roll;

FIG. 6E is a side view showing a state where the abutting portion is retreated from a first paper transport path;

FIG. 6F is a side view showing a state where the paper is transported to the downstream side by the second transport roll;

FIG. 7A is a side view showing a state of a hook and a catch in a case where the abutting portion returns from a retreated position to the standby position;

FIG. 7B is a side view showing a state where the catch pushes up the hook;

FIG. 7C is a side view showing a state where the hook is locked to the catch;

FIG. 8 is a conceptual view showing a relationship between a position and a speed of the carriage;

FIG. 9A is a partially enlarged view showing backlash between a rack gear and a pinion gear; and

FIG. 9B is a partially enlarged view showing states of the rack gear and the pinion gear in a case where the carriage is biased to the downstream side in the paper transport direction by a spring.

### DETAILED DESCRIPTION

Hereinafter, a paper transport apparatus according to an exemplary embodiment of the present disclosure will be described with reference to the drawings. Components indicated by the identical reference symbol in the respective drawings mean the identical components. However, unless otherwise specified in the specification, the number of each component is not limited to one, and a plurality of components may be present.

In addition, description of redundant configurations and reference symbols in the respective drawings is omitted in some cases. The present disclosure is not limited to the following exemplary embodiment and can be implemented with appropriate modifications such as omission of configurations, replacement with different configurations, and use in combination with one exemplary embodiment and various types of modification examples, without departing from the scope of the present disclosure.

### Image Forming Apparatus 100

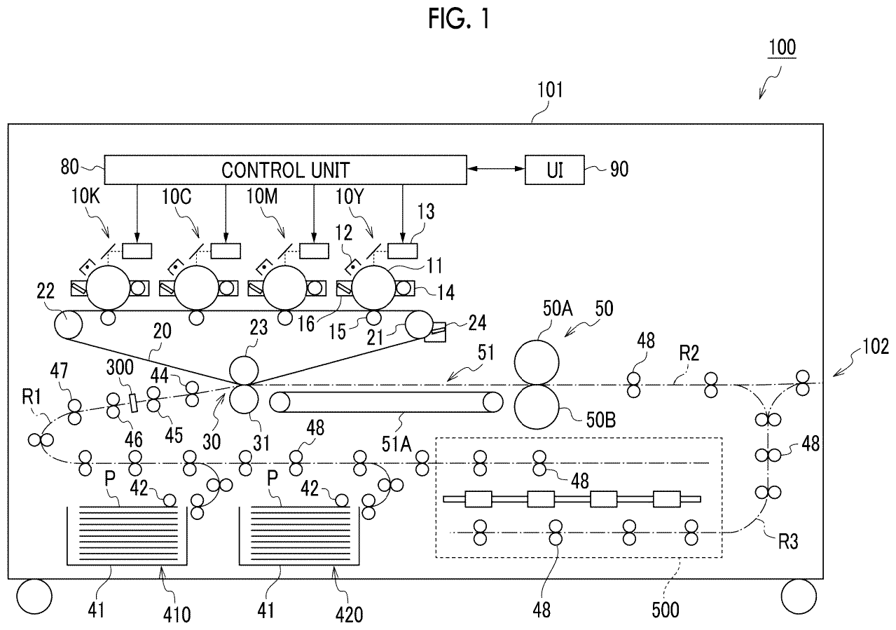

FIG. 1 is a view of an image forming apparatus 100 which is an example of the paper transport apparatus according to the exemplary embodiment of the present disclosure, which is viewed from a front side. The image forming apparatus 100 shown in FIG. 1 has a so-called tandem type configuration. The image forming apparatus 100 includes a plurality of image forming units 10 (10Y, 10M, 10C, 10K) that form a toner image of each color component through an electrophotographic method.

In addition, the image forming apparatus 100 is provided with a control unit 80 that controls an operation of each device and each unit configuring the image forming apparatus 100. In addition, the image forming apparatus 100 is provided with a user interface unit (UI) 90. The user interface unit (UI) 90 is configured by a display panel, outputs an instruction received from a user to the control unit 80, and presents information from the control unit 80 to the user.

In addition, the image forming apparatus 100 includes an intermediate transfer belt 20 and a secondary transfer device 30. The intermediate transfer belt 20 sequentially transfers (primarily transfers) each color component toner image formed by each image forming unit 10 and holds the toner image. The secondary transfer device 30 collectively transfers (secondarily transfers) the toner images on the intermediate transfer belt 20 to paper P.

Herein, each of the image forming units 10, the intermediate transfer belt 20, and the secondary transfer device 30 can be regarded as a toner image forming unit that forms an image on the paper P. In addition, the image forming apparatus 100 is provided with a first paper transport path R1, a second paper transport path R2, and a third paper transport path R3. The first paper transport path R1 is a path through which the paper P transported toward the secondary transfer device 30 passes. The second paper transport path R2 is a path through which the paper P passes after passing through the secondary transfer device 30. The third paper transport path R3 is a path that branches from the second paper transport path R2 on a downstream side of a fixing device 50 (to be described later) and that extends to a lower side of the first paper transport path R1.

In addition, the image forming apparatus 100 is provided with a reversing mechanism 500 that transports the paper P from the third paper transport path R3 to the first paper transport path R1 and that reverses the front and back of the paper P. Further, an opening 102 is formed in a housing 101 of the image forming apparatus 100.

Here, the paper P transported along the second paper transport path R2 is discharged to the outside of the housing 101 through the opening 102 and is stacked on a paper stacking portion (not shown). A processing device (not shown) can also be provided adjacent to the housing 101 and perform additional processing, such as punching, on the paper P discharged from the opening 102.

In addition, the image forming apparatus 100 is provided with a first paper supply device 410 that supplies the paper P to the first paper transport path R1. In addition, a second paper supply device 420 that supplies the paper P to the first paper transport path R1 is provided on an upstream side of the first paper supply device 410 in a transport direction of the paper P (hereinafter, referred to as a “paper transport direction”) with respect to the first paper supply device 410.

The first paper supply device 410 and the second paper supply device 420 are configured in the same manner. Each of the first paper supply device 410 and the second paper supply device 420 is provided with a paper accommodation portion 41 that accommodates the paper P and an ejection roll 42 that ejects and transports the paper P accommodated in the paper accommodation portion 41.

In addition, a first transport roll 44 that transports the paper P on the first paper transport path R1 toward the secondary transfer device 30 is provided on the first paper transport path R1 on the upstream side of the secondary transfer device 30. Further, on the upstream side of the first transport roll 44, a second transport roll 45 that transports the paper P toward the first transport roll 44, a third transport roll 46 that transports the paper P toward the second transport roll 45, and a fourth transport roll 47 that transports the paper P toward the third transport roll 46 are provided.

In addition to the transport rolls, a plurality of transport rolls 48 that transport the paper P positioned on the paper transport paths are provided in the first paper transport path R1, the second paper transport path R2, and the third paper transport path R3.

In addition, an abutting portion 300, which is formed of stainless steel and against which a leading end portion of the paper P is abutted, is provided between the second transport roll 45 and the third transport roll 46. In the present exemplary embodiment, the leading end portion of the paper P being transported is abutted against the abutting portion 300, so that skew of the paper P (slanting and inclination of the paper P with respect to the paper transport direction) is corrected. After the skew of the paper P is corrected by the abutting portion 300, the abutting portion 300 retreats from the first paper transport path R1.

In addition, the fixing device 50 that fixes an image secondarily transferred onto the paper P by the secondary transfer device 30 to the paper P is provided on the second paper transport path R2. The fixing device 50 is provided with a heating roll 50A that is heated by a built-in heater (not shown) and a pressing roll 50B that presses the heating roll 50A. In the fixing device 50, as the paper P passes between the heating roll 50A and the pressing roll 50B, the paper P is pressurized and heated. Accordingly, the image on the paper P is fixed to the paper P.

In addition, a transport device 51 that transports the paper P, which has passed through the secondary transfer device 30, to the fixing device 50 is provided between the secondary transfer device 30 and the fixing device 50. Herein, the transport device 51 has a belt 51A that moves in a circular path. The paper P is placed on the belt 51A and the paper P is transported.

Herein, each of the image forming units 10 includes a photosensitive drum 11 that is rotatably attached. In addition, a charging device 12 that charges the photosensitive drum 11, an exposure device 13 that exposes the photosensitive drum 11 and that writes an electrostatic latent image, and a developing device 14 that visualizes the electrostatic latent image on the photosensitive drum 11 with a toner are provided around the photosensitive drum 11.

Further, each of the image forming units 10 is provided with a primary transfer device 15 that transfers each color component toner image formed on the photosensitive drum 11 to the intermediate transfer belt 20 and a drum cleaning device 16 that removes a residual toner on the photosensitive drum 11.

The intermediate transfer belt 20 is provided to be hung on three roll members 21 to 23 and to rotate. Among the three roll members 21 to 23, the roll member 22 drives the intermediate transfer belt 20.

In addition, the roll member 23 is disposed to face a secondary transfer roll 31 with the intermediate transfer belt 20 sandwiched therebetween, and the secondary transfer device 30 is configured by the secondary transfer roll 31 and the roll member 23. A belt cleaning device 24 that removes a residual toner on the intermediate transfer belt 20 is provided at a position facing the roll member 21 with the intermediate transfer belt 20 sandwiched therebetween.

In addition, in the image forming apparatus 100 of the present exemplary embodiment, an image can be formed on one side of the paper P supplied from the first paper supply device 410 and the like, and an image can be formed on the other side of the paper P.

To describe more specifically, in the image forming apparatus 100, the front and back of the paper P which has passed through the fixing device 50 are reversed by the reversing mechanism 500, and the paper P of which the front and back are reversed is transported to the secondary transfer device 30 again. Then, the image is transferred to the other side of the paper P by the secondary transfer device 30. After then, the paper P passes through the fixing device 50 again, and the transferred image is fixed to the paper P. Accordingly, the image is formed not only on the one side of the paper P but also on the other side of the paper P.

### Reversing Mechanism 500

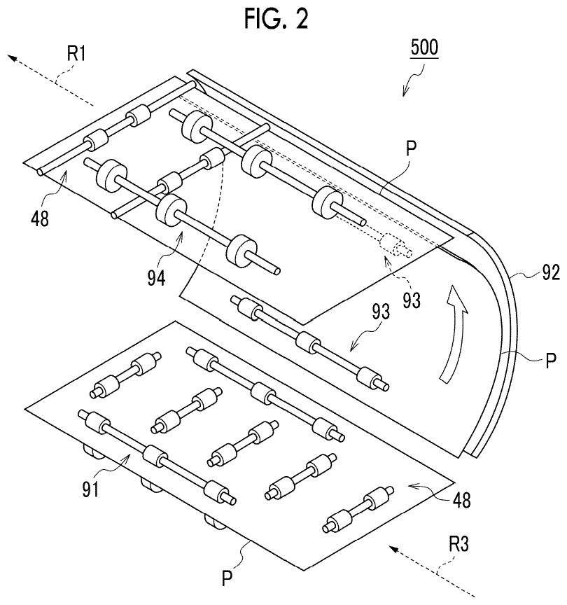

FIG. 2 is a view for describing the reversing mechanism 500.

As described above, the plurality of transport rolls 48 that transport the paper P along the third paper transport path R3 are provided in the third paper transport path R3. In addition, the plurality of transport rolls 48 that transport the paper P along the first paper transport path R1 are also provided in the first paper transport path R1.

In addition, a transport roll 91 that transports the paper P toward a direction orthogonal (intersecting) to the paper transport direction in the third paper transport path R3 is provided in the third paper transport path R3.

Further, a guide member 92 is provided in the third paper transport path R3. The guide member 92 guides the paper P such that the paper P transported by the transport roll 91 moves upward and the paper P moved upward further moves toward the first paper transport path R1. Furthermore, a transport roll 93 that nips the paper P guided by the guide member 92 with the leading end portion facing upward and that further transports the paper P upward is provided in the third paper transport path R3.

In addition, a transport roll 94 that transports the paper P, which has been transported by the transport roll 93, to a place determined in advance on the first paper transport path R1 is provided in the first paper transport path R1.

Each of the transport rolls 48 is configured by a pair of roll-shaped members and rotates while sandwiching the paper P with the pair of roll-shaped members to transport the paper P. In addition, FIG. 2 only shows one roll-shaped member of the pair of roll-shaped members. Further, the transport roll 91, the transport roll 93, and the transport roll 94 also rotate while sandwiching the paper P with the pair of roll-shaped members to transport the paper P.

In addition, one roll-shaped member provided at the transport roll 48 can be separated from the other roll-shaped member. In addition, the same applies to the transport roll 91 and the transport roll 94, and one roll-shaped member can be separated from the other roll-shaped member. Further, although not shown, a separating mechanism (not shown) that separates one roll-shaped member from the other roll-shaped member is provided. The separating mechanism is configured by existing technology such as a motor and a cam.

In a case where the reversing mechanism 500 reverses the front and back of the paper P, first, the paper P is transported along the third paper transport path R3 by the transport rolls 48. In this case, one roll-shaped member of the transport roll 91 provided in the third paper transport path R3 is separated from the other roll-shaped member. Next, one roll-shaped member of the transport roll 48 is separated from the other roll-shaped member, and the one roll-shaped member of the transport roll 91 is pressed against the other roll-shaped member via the paper P.

Next, the transport roll 91, the transport roll 93, and the transport roll 94 are rotationally driven, and the paper P is transported toward the first paper transport path R1. In this case, the one roll-shaped member of the transport roll 48 provided in the first paper transport path R1 is separated from the other roll-shaped member.

In a case where the paper P is transported to the place determined in advance on the first paper transport path R1, the rotational drive of the transport roll 91, the transport roll 93, and the transport roll 94 is stopped. After then, one roll-shaped member of the transport roll 94 is separated from the other roll-shaped member. In addition, the one roll-shaped member of the transport roll 48 provided in the first paper transport path R1 is pressed against the other roll-shaped member via the paper P.

Next, the transport roll 48 is rotationally driven, and the paper P is transported along the first paper transport path R1. In this case, a state where the front and back of the paper P are already reversed is caused. Herein, in the reversing mechanism 500 according to the present exemplary embodiment, the front and back are reversed without the leading end portion and a trailing end portion being switched in the paper transport direction. On the other hand, in the reversing mechanism 500 according to the present exemplary embodiment, one side end of the paper (a side end connecting the leading end portion and the trailing end portion of the paper P) and the other side end are switched.

### Abutting Portion 300

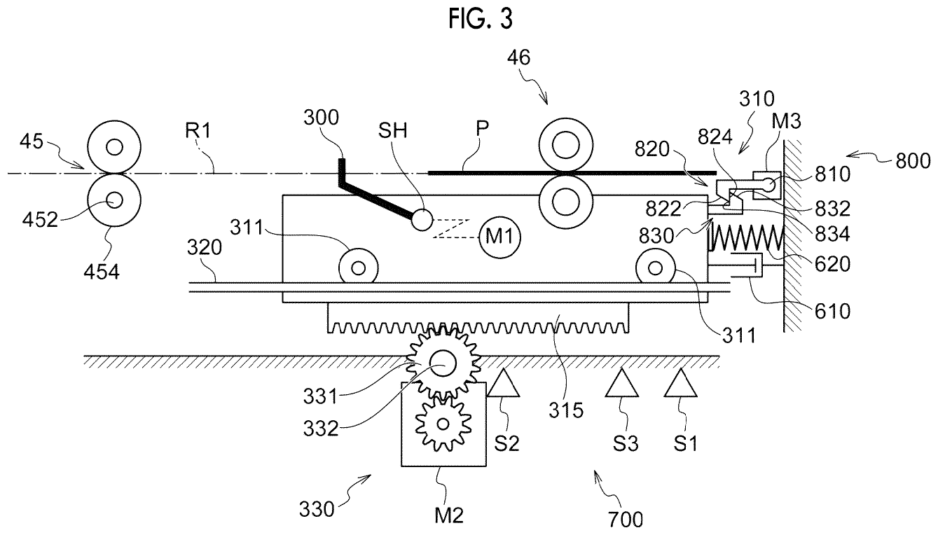

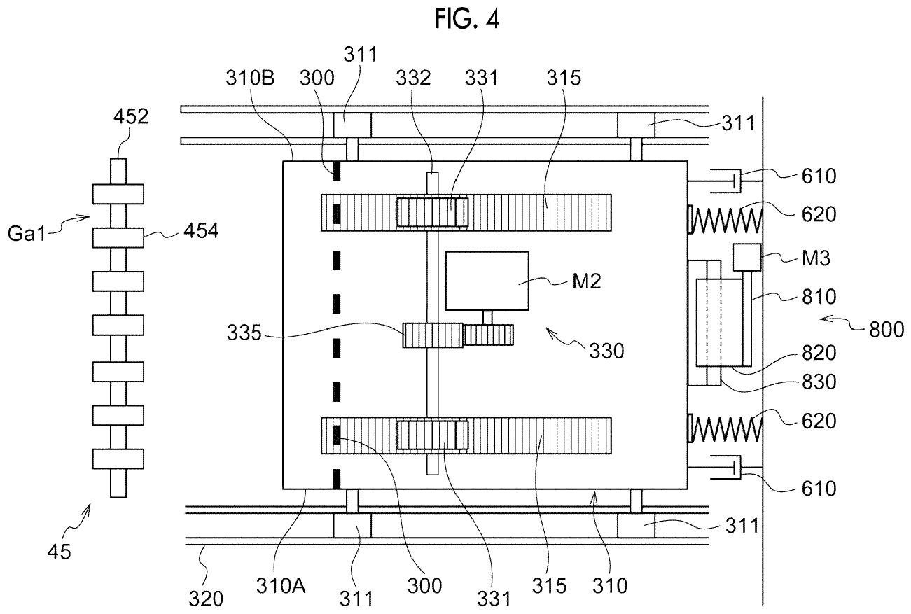

FIG. 3 is a side view of a periphery of the abutting portion 300 shown in FIG. 1. In addition, FIG. 4 is a plan view of the periphery of the abutting portion 300 shown in FIG. 1. FIG. 3 shows a side view in a case where the image forming apparatus 100 shown in FIG. 1 is viewed from a rear side is shown. In addition, FIG. 4 shows only a portion of the abutting portion 300, which protrudes to the first paper transport path R1 (see FIG. 1).

As shown in FIG. 3, the abutting portion 300 is disposed to be movable between the second transport roll (transport unit) 45 and the third transport roll 46 along the paper transport direction (first paper transport path R1). In addition, the abutting portion 300 is formed in an L-shape and is provided to be rotatable (swingable) about one end fixed to a shaft SH (to be described later). To describe more specifically, the abutting portion 300 is provided such that the other end is movable forward and backward with respect to the first paper transport path R1 by rotating (swinging) one end of the abutting portion 300 about the center.

In addition, as shown in FIG. 4, a plurality of abutting portions 300 are provided in the direction intersecting (orthogonal to) the paper transport direction. Further, each of the abutting portions 300 is disposed in a state of being arranged at an interval determined in advance.

### Moving Unit 700

Although not shown in FIG. 1, the image forming apparatus 100 is provided with a moving unit (a transport unit, a moving mechanism) 700 that moves the abutting portion 300, which is disposed between the second transport roll 45 and the third transport roll 46, along the paper transport direction.

The moving unit 700 is provided to be reciprocatable along the paper transport direction and is provided with a carriage 310 that supports the abutting portion 300. In addition, the moving unit 700 is provided with a rail 320 that guides the carriage 310 along the paper transport direction. Further, the moving unit 700 is provided with a drive unit 330 that supplies a drive force for moving the carriage 310.

### Carriage 310

The carriage 310 is a housing that holds the plurality of abutting portions 300. The carriage 310 has the shaft SH that supports one end of each of the abutting portion 300. The shaft SH is rotatably provided, and the plurality of provided abutting portions 300 are integrally rotatable (swingable) around the shaft SH.

In addition, the carriage 310 has a motor M1 that rotates the shaft SH. Further, the carriage 310 has wheels 311 supported by the rail 320. Furthermore, the carriage 310 has a rack gear 315 that is disposed along the paper transport direction.

Herein, as shown in FIG. 4, two wheels 311 and two rack gears 315 are provided at positions different from each other in the direction intersecting (orthogonal to) the paper transport direction.

Specifically, one thereof is provided on a rear side end 310A side of the carriage 310, and the other thereof is provided on a front side end 310B side of the carriage 310, with a center position of the carriage 310 in the direction intersecting (orthogonal to) the paper transport direction sandwiched therebetween. In addition, the rail 320 that supports the wheels 311 is provided on each of the rear side and the front side of the carriage 310.

### Drive Unit 330

The drive unit 330 includes a pinion gear (a gear, a rotating portion) 331 that meshes with the rack gear 315. In addition, the drive unit 330 has a gear shaft 332 that is provided along the direction orthogonal to the paper transport direction and that supports the pinion gear 331 and a motor (drive source) M2 that rotates the pinion gear 331 via the gear shaft 332. For example, the motor M2 is configured by a stepping motor.

Further, as shown in FIG. 3, the drive unit 330 has a first sensor S1, a second sensor S2, and a third sensor S3 that detect the carriage 310. The second sensor S2 is provided on the downstream side of the first sensor S1 in the paper transport direction. The third sensor S3 is provided between the first sensor S1 and the second sensor S2.

The first sensor S1 detects that the abutting portion 300 is at a standby position where the abutting portion 300 waits for the paper P to be transported from the upstream side via the carriage 310. In addition, the second sensor S2 detects that the abutting portion 300 is at a retreated position to which the abutting portion 300 is retreated from the first paper transport path R1 via the carriage 310.

Further, the third sensor S3 detects that the abutting portion 300 is at a position where a release mechanism of the motor M2, which will be described later, is driven via the carriage 310. Each unit of the drive unit 330 is fixed to the housing 101 (see FIG. 1) of the image forming apparatus 100.

Herein, as shown in FIG. 4, two pinion gears 331 are provided at positions different in the direction intersecting (orthogonal to) the paper transport direction to mesh with the two rack gears 315 provided as described above, respectively. Further, the two pinion gears 331 are provided on one gear shaft 332. Therefore, the two pinion gears 331 rotate in synchronization with each other.

In addition, in the present exemplary embodiment, the gear shaft 332 is rotated by receiving the driving from the motor M2 at one place of an axial central portion. Specifically, the gear shaft 332 is rotated as a central gear 335 fixed to the axial central portion of the gear shaft 332 is rotated by receiving the driving from the motor M2.

### Motor and Release Mechanism

The motor M2 applies a drive force to the carriage 310 via the central gear 335, the gear shaft 332, the pinion gear 331, and the rack gear 315. The carriage 310 receives a drive force from the motor M2 in a state of holding the abutting portion 300. Accordingly, the abutting portion 300 reciprocates between the standby position and the retreated position.

In addition, the motor M2 includes the release mechanism that releases transmission of a drive force from the motor M2 to the central gear 335 (in other words, transmission of the drive force from the motor M2 to the abutting portion 300). The release mechanism is driven while the abutting portion 300 is moving from the retreated position to the standby position.

The configuration of the release mechanism is not particularly limited, and the release mechanism is a charge device that releases an excitation state of the motor M2 that is a stepping motor or a clutch that releases transmission of a rotational force of the motor M2. In a case where the release mechanism is driven while the motor M2 is being driven, the motor M2 idles, and a drive force is not transmitted to the central gear 335. Accordingly, the carriage 310 moves toward the upstream side in the paper transport direction (a standby position side of the abutting portion 300) due to an inertial force.

### Attenuation Mechanism 600

An attenuation mechanism 600 is configured to include a damper 610 and a spring 620 that is an elastic body for biasing the carriage 310 in the paper transport direction.

The damper 610 is pressed from the carriage 310 in a case where the carriage 310 moves to the upstream side in the paper transport direction (from the retreated position to the standby position of the abutting portion 300) due to an inertial force after the release mechanism of the motor M2 operates. In this case, the damper 610 converts kinetic energy of the carriage 310 into thermal energy. Accordingly, energy of movement of the carriage 310 to the standby position is attenuated, and the carriage 310 is stopped.

The spring 620 is also pressed by the carriage 310 in a case where the carriage 310 moves from the retreated position to the standby position of the abutting portion 300 due to an inertial force after the release mechanism of the motor M2 operates, in the same manner as the damper 610. In this case, the spring 620 increases a biasing force applied to the carriage 310 on a retreated position side while being compressed. Accordingly, the speed of the carriage 310 is attenuated, and the carriage 310 is stopped.

In a case where the carriage 310 is stopped, a positioning mechanism 800, which will be described later, operates. Accordingly, movement of the carriage 310 to the downstream side in the paper transport direction is restricted. For this reason, the carriage 310 is not pushed back by the spring 620 in a compressed state. On the other hand, the spring 620 biases the carriage 310 to the retreated position side on the downstream side in the paper transport direction in a state where the abutting portion 300 is stationary at the standby position.

As shown in FIG. 4, the two attenuation mechanisms 600 of the present exemplary embodiment are provided at positions different in the direction intersecting (orthogonal to) the paper transport direction from each other. Specifically, the attenuation mechanism 600 is provided on each of the rear side and the front side of the carriage 310 with the center position of the carriage 310 in the direction intersecting (orthogonal to) the paper transport direction sandwiched therebetween.

### Positioning Mechanism 800

The positioning mechanism 800 is a restricting mechanism that regulates movement of the abutting portion 300 from the standby position to the retreated position side. The positioning mechanism 800 is configured to include a motor M3, a shaft 810, a hook 820, and a catch 830.

The shaft 810 is a rod-shaped shaft member that is axially rotated by a drive force of the motor M3. The hook 820 is a locking piece fixed to the shaft 810 and rotates with the axial rotation of the shaft 810.

A bottom surface of the hook 820 is an inclined surface 822 that is inclined downward toward the upstream side in the paper transport direction. In addition, a locking surface 824 that extends upward from a lower end portion of the inclined surface 822 is formed on the hook 820.

The catch 830 is a receiving member fixed to the carriage 310. An upper surface of the catch 830 is an inclined surface 832 that is inclined downward toward the upstream side in the paper transport direction. In addition, a locking surface 834 that extends downward from an upper end portion of the inclined surface 832 is formed on the hook 820.

The hook 820 is locked to the catch 830. In a state where the hook 820 is locked to the catch 830, the locking surface 824 of the hook 820 and the locking surface 834 of the catch 830 are in contact with each other, and movement of the carriage 310 to the downstream side in the paper transport direction is restricted.

### Second Transport Roll 45

Herein, the second transport roll 45 provided on the downstream side of the moving unit 700 in the paper transport direction will be described with reference to FIGS. 3 and 4.

The second transport roll 45 is formed of a pair of roll-shaped members and is rotated by receiving a drive force from a drive source (not shown). Each of the roll-shaped members of the second transport roll 45 is formed of a rotation shaft 452 provided in the direction orthogonal to the paper transport direction and a cylindrical contact member 454 that is rotated by the rotation shaft 452 and that has an outer peripheral surface coming into contact with the paper P.

In addition, as shown in FIG. 4, a plurality of contact members 454 are provided. The respective contact members 454 are disposed at positions different from each other in the direction orthogonal to the paper transport direction.

Further, as shown in FIG. 4, a gap Ga1 is formed between the contact members 454 adjacent to each other. Each gap Ga1 and each abutting portion 300 are disposed at corresponding positions in the direction intersecting (orthogonal to) the paper transport direction. Accordingly, each abutting portion 300 moving toward the downstream side in the paper transport direction passes through the gap Ga1 and reaches a place beyond the second transport roll 45 (to be described later).

### Reciprocation of Carriage 310

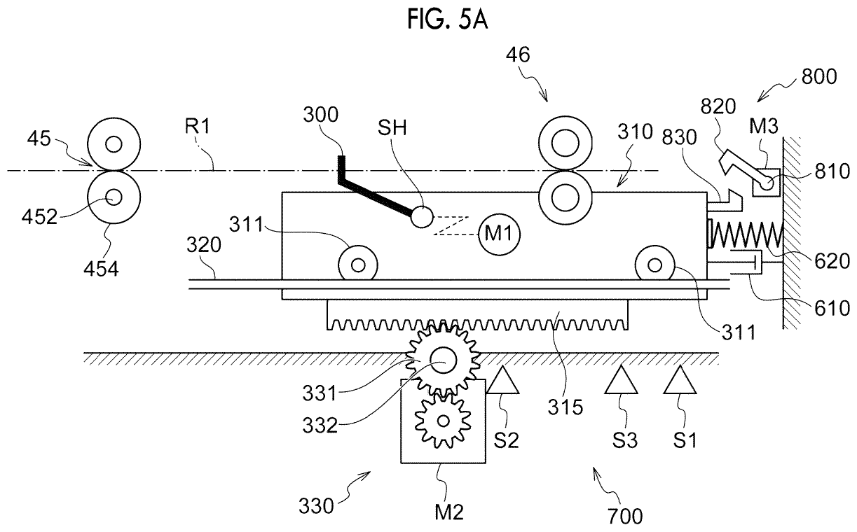

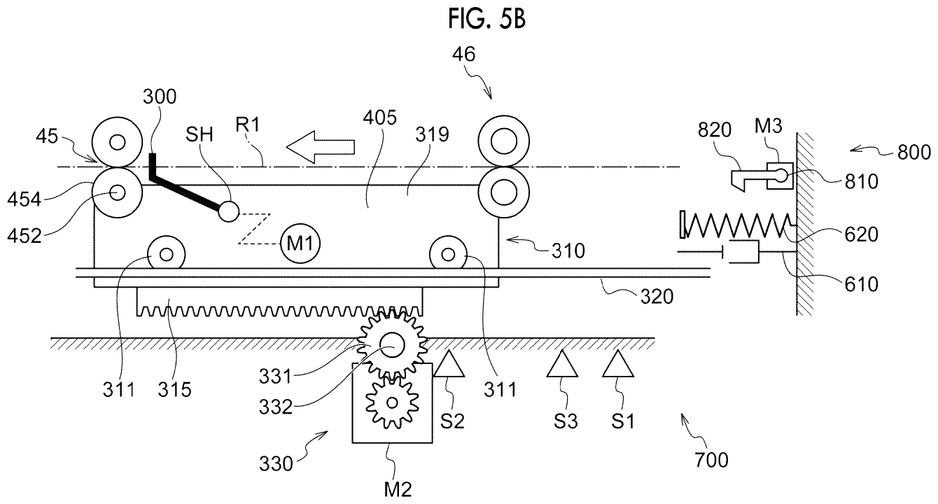

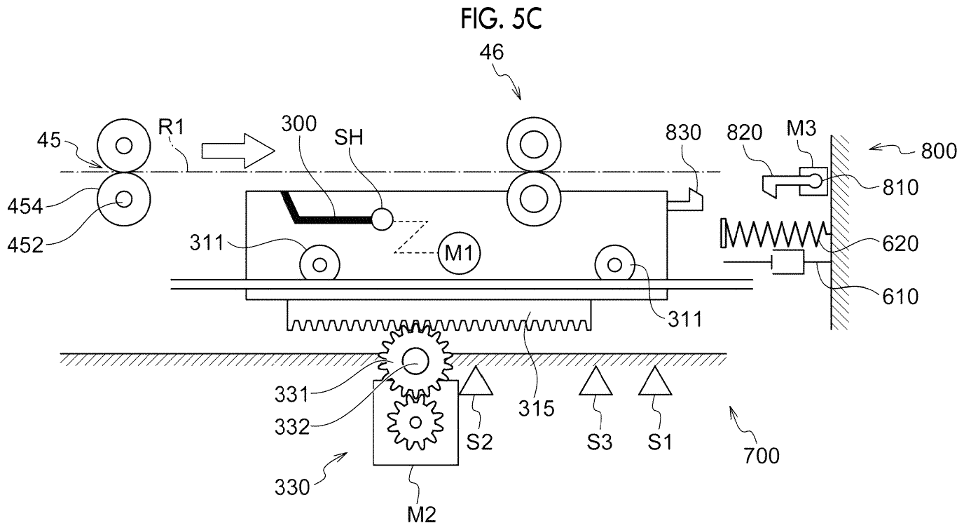

Next, a state of each unit in a case where the carriage 310 reciprocates will be described with reference to FIGS. 5A to 5C. Herein, FIGS. 5A to 5C are views showing a state of each unit in a case where the abutting portion 300 reciprocates.

First, a state where the carriage 310 starts to move to the downstream side in the paper transport direction will be described as shown in FIG. 5A. Initially, the carriage 310 is in a state of being disposed on the upstream side in the paper transport direction, and the carriage 310 receives driving of the motor M2 via the pinion gear 331 and the rack gear 315 and starts to move to the downstream side in the paper transport direction.

In this case, the hook 820 is rotated by receiving the driving of the motor M3, and a locked state with the catch 830 is released. Accordingly, movement of the carriage 310 to the downstream side in the paper transport direction is allowed.

Next, as shown in FIG. 5B, by receiving the driving of the motor M2, the carriage 310 moves at a constant speed to the downstream side in the paper transport direction.

Next, a state where the carriage 310 moves to the upstream side in the paper transport direction will be described as shown in FIG. 5C. In this state, the motor M2 rotates in a direction opposite to a rotation direction in FIGS. 5A and 5B, and the carriage 310 moves to the upstream side in the paper transport direction.

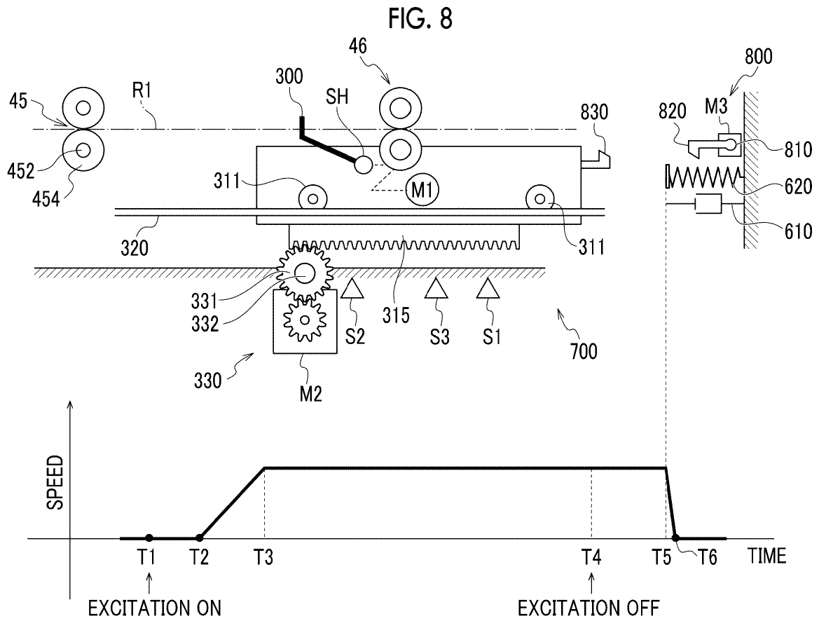

FIG. 8 shows an excitation state of the motor M2 and the speed of the carriage 310 in a case where the motor M2 rotates in the rotation direction in FIG. 5C. In a case where the motor M2 is excited (time T1), a drive force is transmitted to the carriage 310 (time T2). Then, the carriage 310 moves to the upstream side in the paper transport direction while being gradually accelerated and moves at a top speed in a case where a drive force is sufficiently transmitted (time T3).

Then, in a case where the third sensor S3 detects the carriage 310 before the abutting portion 300 returns to the standby position, the release mechanism of the motor M2 is driven, and the motor M2 idles (time T4). Accordingly, the carriage 310 moves to the upstream side in the paper transport direction due to an inertial force, not through the drive control of the motor M2.

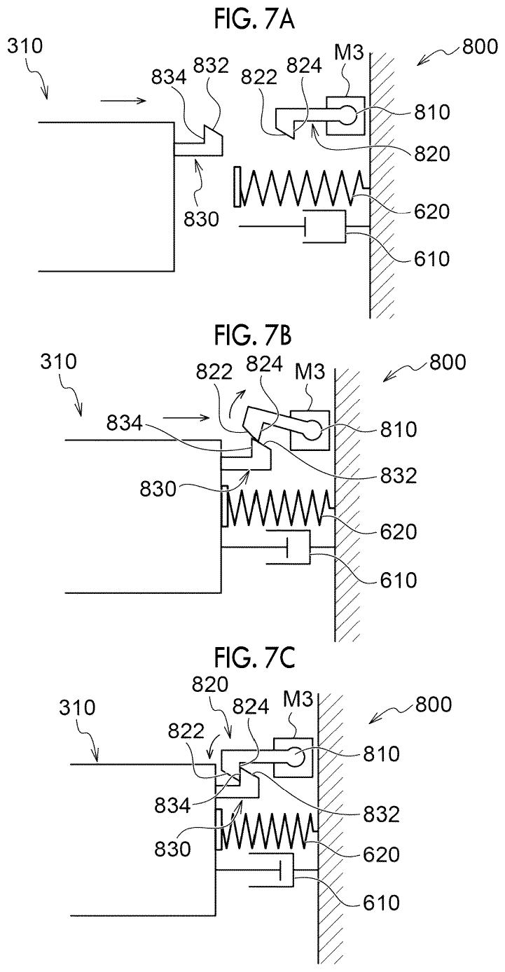

Next, in a case where the abutting portion 300 returns to the standby position as shown in FIG. 7A, the inclined surface 832 of the catch 830 fixed to the carriage 310 comes into contact with the inclined surface 822 of the hook 820 and pushes up the hook 820 as shown in FIG. 7B. In this case, the motor M3 is not driven, and the hook 820 is pushed up by free movement.

In addition, the carriage 310 presses the damper 610 and the spring 620, kinetic energy is attenuated by the damper 610, and a biasing force to the downstream side in the paper transport direction is received by the spring 620. Accordingly, as shown in FIG. 8, the speed of the carriage 310 starts to decrease (time T5).

Next, as shown in FIG. 7C, the hook 820 rides on the catch 830, the hook 820 falls due to the weight thereof, and the hook 820 is automatically locked to the catch 830. A spring that biases the hook 820 to have a posture shown in FIG. 7A or 7C may be provided in the hook 820 so that the hook 820 is easily automatically locked to the catch 830.

In this case, the carriage 310 receives a biasing force to the downstream side in the paper transport direction with the spring 620, and the locking surface 834 of the catch 830 is pressed against the locking surface 824 of the hook 820. Accordingly, the carriage 310 stops, and the movement to the downstream side in the paper transport direction is restricted (time T6 in FIG. 8). In a case where the carriage 310 stops, a release function of the motor M2 also stops, and a drive force of the motor M2 is transmitted to the central gear 335.

### Skew Correction

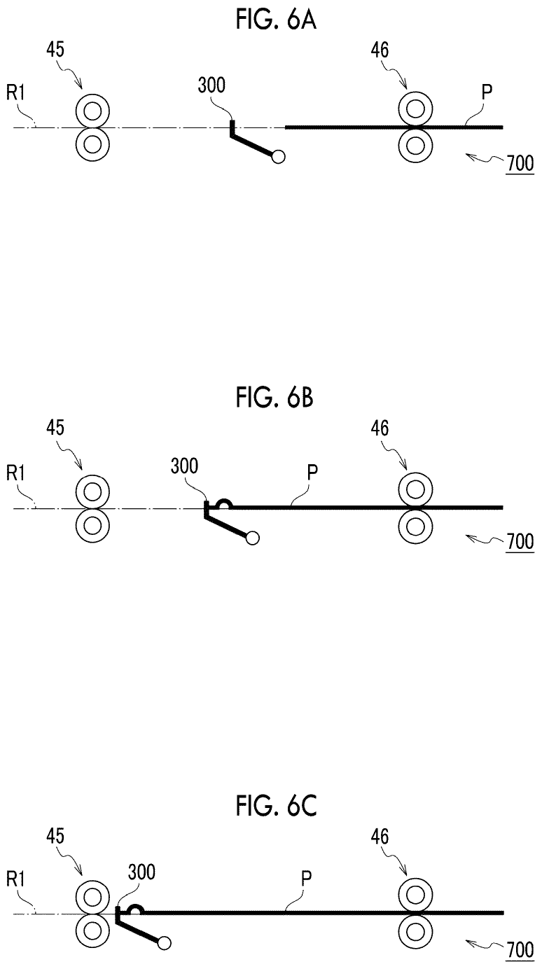

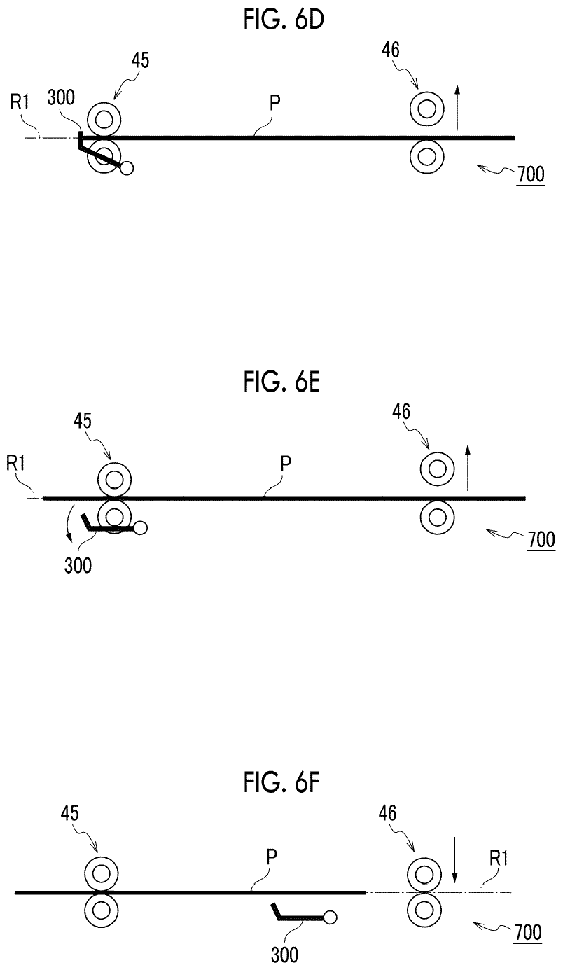

Movement of each unit in a case where skew correction of the paper P is performed will be described with reference to FIGS. 6A to 6F. Herein, FIGS. 6A to 6F are views showing movement of each unit in a case where the skew correction is performed.

First, an outline of the movement of each unit will be described. As shown in FIGS. 6A to 6D, the abutting portion 300 is moved toward the downstream side in the paper transport direction by the moving unit 700.

Herein, a movement speed of the carriage 310 and a speed at which the paper P is transported by the third transport roll 46 are set such that the speed at which the paper P is transported by the third transport roll 46 is greater than the movement speed of the carriage 310 (see FIG. 3) in the moving unit 700. For this reason, in a case where the paper P is transported by the third transport roll 46, the paper P gradually approaches the abutting portion 300, and then the leading end portion of the paper P abuts against the abutting portion 300.

Accordingly, a loop (bending) is generated in the paper P, and skew of the paper P is corrected. In order to prevent the paper P from being damaged due to abutting of the paper P against the abutting portion 300, a speed difference between the movement speed of the carriage 310 and the speed at which the paper P transported by the third transport roll 46 is set.

Hereinafter, movement of each unit will be described in more detail.

As shown in FIG. 6A, the paper P is transported from the upstream side by the third transport roll 46 in a state where the abutting portion 300 is disposed at the standby position where the abutting portion 300 enters the transport path of the paper P and waits for the paper P. Next, in a case where the leading end portion of the paper P is detected by a paper detection sensor (not shown), the motor M2 (see FIG. 3) is driven, and movement of the carriage 310 (see FIG. 3) to the downstream side in the paper transport direction is started.

The carriage 310 is accelerated by receiving the driving of the motor M2 and then moves to the downstream side in the paper transport direction at a constant speed. The speed of the carriage 310 moving at a constant speed is slower than the speed at which the paper P is transported by the third transport roll 46.

Then, as shown in FIG. 6B, the leading end portion of the paper P abuts against the abutting portion 300, and the paper P is continuously transported by the third transport roll 46 in this state (see FIG. 6C). Accordingly, the leading end of the paper P is aligned in the direction orthogonal to the paper transport direction, and the skew of the paper P is corrected.

Next, as shown in FIG. 6D, the abutting portion 300 against which the leading end portion of the paper P is pressed reaches the place beyond the second transport roll 45. In this case, the paper P is held (nipped) by the second transport roll 45, and the second transport roll 45 starts to transport the paper P.

Then, after the paper P is held by the second transport roll 45, one roll-shaped member of a pair of roll-shaped members configuring the third transport roll 46 is separated from the other roll-shaped member.

After then, as shown in FIG. 6E, the abutting portion 300 reaches the retreated position. Then, as the motor M1 (see FIG. 3) is driven, the abutting portion 300 rotates downward with the shaft SH as a rotation shaft and retreats from the first paper transport path R1. Next, as shown in FIGS. 6E and 6F, the paper P is further transported to the downstream side by the second transport roll 45.

On the other hand, as shown in FIG. 6F, the abutting portion 300 that is away from the first paper transport path R1 moves toward the upstream side in the paper transport direction and returns to the original state (the state in FIG. 6A). Herein, in the present exemplary embodiment, the second sensor S2 (see FIG. 3) stops detecting the carriage 310 after the abutting portion 300 reaches the second transport roll 45.

Accordingly, the motor M2 is rotated in a reverse direction, and the carriage 310 is driven toward the upstream side in the paper transport direction. By receiving the driving of the motor M2, the carriage 310 moves to the upstream side in the paper transport direction.

In a case where the carriage 310 is detected by the third sensor S3 (see FIG. 3), the release mechanism of the motor M2 is driven, and transmission of a drive force of the motor M2 is released. Accordingly, the carriage 310 is moved by an inertial force, and the abutting portion 300 returns to the standby position. In the present exemplary embodiment, the motor M1 is rotated in a reverse direction in a case where the carriage 310 is moving toward the upstream side. Accordingly, the abutting portion 300 protrudes again on the first paper transport path R1.

### Actions and Effects

In the image forming apparatus 100 of the present exemplary embodiment, the motor M2 of the drive unit 330 applies a drive force, which is from the retreated position to the standby position, to the carriage 310 that holds the abutting portion 300 (FIG. 5C). Then, since braking of the carriage 310 by the motor M2 is released by the release mechanism, the abutting portion 300 may be moved to the standby position by an inertial force. Accordingly, the abutting portion 300 may be returned to the standby position earlier compared to a case where the abutting portion 300 is decelerated through the drive control of the motor M2. Accordingly, a time interval for transporting the paper P can be shortened.

On the other hand, deceleration through the drive control of the motor M2, which is a stepping motor, controls a stop operation through step-down and excitation. In this case, deceleration, which is gradual reduction in speed, is caused, and time until the abutting portion 300 moves to the standby position is lengthened.

In addition, the image forming apparatus 100 of the present exemplary embodiment includes the attenuation mechanism 600 that attenuates energy of movement of the carriage 310 holding the abutting portion 300 to stop the carriage 310 after the release mechanism of the motor M2 is operated. Accordingly, damage to the carriage 310 may be suppressed compared to a case where the carriage 310 collides with a stopper and stops.

In addition, the image forming apparatus 100 of the present exemplary embodiment includes the positioning mechanism 800. The positioning mechanism 800 regulates movement of the abutting portion 300 from the standby position to the retreated position side (the movement of the carriage 310 to the downstream side in the paper transport direction). Accordingly, the movement of the abutting portion 300 from the standby position to the retreated position side may be suppressed.

In addition, in the image forming apparatus 100 of the present exemplary embodiment, the attenuation mechanism 600 including the elastic body biases the abutting portion 300 to the retreated position side in a state where the abutting portion 300 is stationary at the standby position. Accordingly, movement of the abutting portion 300 from the standby position to the retreated position side (the movement of the carriage 310 to the upstream side in the paper transport direction) may be suppressed. In addition, in a case where an engagement state between the hook 820 and the catch 830 is released, a thrust by the spring 620 of the attenuation mechanism 600 is generated, and a time lag that occurs until a drive force is transmitted from the motor M2 is unlikely to occur.

In addition, in the image forming apparatus 100 of the present exemplary embodiment, the hook 820 of the positioning mechanism 800 is automatically locked to the catch 830 fixed to the carriage 310, and the locked state is released in a case where the carriage 310 starts to move. As described above, since the hook 820 is automatically locked, a load is reduced compared to a case where power is used. In addition, since the hook 820 is released from the locked state in a case where the carriage 310 starts to move, necessary movement is not hindered.

In addition, in the image forming apparatus 100 of the present exemplary embodiment, the drive unit 330 is configured to include the motor M2 that is a stepping motor, and the release mechanism of the motor M2 is a charge device that releases the excitation state of the motor M2 or a clutch that releases transmission of a rotational force of the motor M2.

In a case where the excitation state of the motor M2 is released by the charge device, the motor M2 can be idled. Therefore, the abutting portion 300 may be moved to the standby position by an inertial force. Similarly, in a case where the clutch releases transmission of a rotational force of the motor M2, the abutting portion 300 may be moved to the standby position by the inertial force without being affected by motor braking.

In general, in a case where the abutting portion 300 is separated from the leading end portion of the paper P before the paper P is held by the second transport roll 45, the paper P is skewed again in some cases until the paper P reaches the second transport roll 45 after being separated from the abutting portion 300.

In the present exemplary embodiment, as described above, the leading end portion of the paper P is pressed against the abutting portion 300 until the paper P is held by the second transport roll 45. For this reason, occurrence of skewing again is suppressed.

In addition, in general, skew correction of the paper P can be performed by abutting the paper P against the stopped abutting portion 300. However, in this case, in order to prevent damage or the like to the paper P caused by the paper P abutting against the abutting portion 300, it is necessary to greatly decrease the speed at which the paper P is transported or to temporarily stop the transport of the paper P. In this case, the number of sheets of paper P that can be transported per unit time is reduced, and productivity is decreased.

On the other hand, in the configuration of the present exemplary embodiment, a speed difference between the movement speed of the carriage 310 and the speed at which the paper P is transported by the third transport roll 46 is set to be small so that the paper P is not damaged. The paper P is abutted against the moving abutting portion 300 with the speed difference set to be small. Therefore, skew correction can be performed while suppressing damage to the paper P without stopping the transport of the paper P. In this manner, productivity is improved compared to a configuration where the abutting portion 300 is stopped.

In addition, as described above, in the present exemplary embodiment, the two sets of rack gears 315 and pinion gears 331 are provided at positions different in the direction intersecting (orthogonal to) the paper transport direction. That is, a drive force for moving the carriage 310 is transmitted at a plurality of positions in the direction intersecting the paper transport direction.

Therefore, inclination of the carriage 310 with respect to the paper transport direction is suppressed compared to a case where driving at one position in the direction intersecting the paper transport direction is transmitted (for example, a case where one set of rack gear 315 and pinion gear 331 is provided). Accordingly, the inclination (positional shift) of the plurality of abutting portions 300 supported by the carriage 310 from a state where the abutting portions 300 are disposed in the direction intersecting (orthogonal to) the paper transport direction is suppressed.

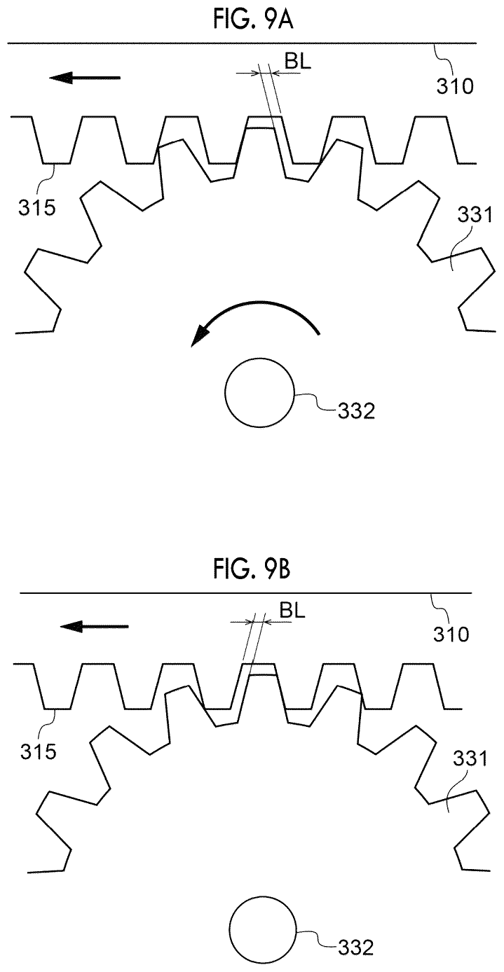

Backlash between the rack gear 315 and the pinion gear 331 will be described with reference to FIGS. 9A and 9B. Herein, FIG. 9A is a view for describing the backlash between the rack gear 315 and the pinion gear 331.

In general, backlash is provided between gears so that a pair of gears can smoothly rotate. As shown in FIG. 9A, backlash is provided also between gears of the rack gear 315 and the pinion gear 331 in the present exemplary embodiment (see BL in FIG. 9A).

Due to the presence of the backlash, the rack gear 315 is moved by being receiving driving from the pinion gear 331 and is in a state of being movable with respect to the pinion gear 331. That is, the rack gear 315 is in a state of having so-called play.

Herein, in a state where the abutting portion 300 is stationary at the standby position, as described above, the carriage 310 is biased to the downstream side in the paper transport direction by the spring 620. In this case, as shown in FIG. 9B, a surface of a tooth of the rack gear 315 on the downstream side in the paper transport direction is in contact with a surface of a tooth of the pinion gear 331 on the upstream side in the paper transport direction.

In a case where the motor M2 is driven in this state and the pinion gear 331 is rotated as indicated by an arrow in FIG. 9A, the motor M2 idles until the backlash is eliminated, and then a drive force is transmitted to the rack gear 315, so that a time lag occurs from the driving of the motor M2 to movement of the carriage 310.

On the other hand, in the present aspect, movement of the carriage 310 to the downstream side in the paper transport direction is restricted by the positioning mechanism 800. Accordingly, even in a state where the abutting portion 300 is stationary at the standby position, a state where backlash to the downstream side in the paper transport direction is canceled can be maintained as shown in FIG. 9A.

### Other Exemplary Embodiments

In the exemplary embodiment, a configuration where the damper 610 and the spring 620 are included as the attenuation mechanism 600, and the hook 820 and the catch 830 are included as the positioning mechanism 800 is adopted. However, the exemplary embodiment of the present disclosure is not limited thereto.

For example, only one of the damper 610 or the spring 620 may be used as the attenuation mechanism 600. For example, even in a case where the damper 610 is omitted, the speed of the carriage 310 is reduced due to a buffering effect of the spring 620. In addition, since the positioning mechanism 800 suppresses the return of the spring 620, it is not necessary to suppress vibration by the damper 610. In addition, for example, even in a case where the spring 620 is omitted, the damper 610 in a compressed state and the carriage 310 come into contact with each other, and the abutting portion 300 is held at the standby position. Further, rubber or sponge which is an elastic body may be used instead of the spring 620.

In addition, for example, an electromagnet for fixing the carriage 310 may be used as the positioning mechanism 800. In this case, the electromagnet is excited in a state where the abutting portion is at the standby position to restrain movement of the carriage 310. In a case where the electromagnet and the attenuation mechanism 600 are used in combination, a magnetic force that can hold the carriage 310 against a biasing force of the spring 620 to the downstream side in the paper transport direction is secured.

In a case where such an electromagnet is used, a fixed state and a released state can be controlled depending on whether or not a voltage is applied. For this reason, a structure of the positioning mechanism 800 may be simplified compared to a configuration where the fixed state and the released state are switched by a mechanical mechanism. The electromagnet may be used in combination with the hook 820 and the catch 830.

In addition, for example, the attenuation mechanism 600 and the positioning mechanism 800 may be omitted. Even in a case where the positioning mechanism 800 is stopped and the motor M2 is not rotated, movement of the carriage 310 can be restrained.

### SUPPLEMENTARY NOTE

(((1)))

A paper transport apparatus comprising:
an abutting portion against which a leading end of paper being transported is abutted and that corrects a slant of the paper;
a drive unit that includes a motor which reciprocates the abutting portion between a standby position where the abutting portion waits for the paper and a retreated position where the abutting portion is retreated from a transport path on a downstream side of the standby position in a transport direction; and
a release mechanism that releases transmission of a drive force from the motor to the abutting portion during movement of the abutting portion to the standby position.
(((2)))

The paper transport apparatus according to (((1))), further comprising: an attenuation mechanism that attenuates movement of energy of the abutting portion to the standby position to stop the abutting portion after the release mechanism is operated.
(((3)))

The paper transport apparatus according to (((1))) or (((2))),
wherein the drive unit includes a gear, and
the attenuation mechanism includes an elastic body, and the abutting portion is biased to the downstream side in the transport direction in a state where the abutting portion is stationary at the standby position.
(((4)))

The paper transport apparatus according to any one of (((1))) to (((3))), further comprising:
a positioning mechanism that regulates movement of the abutting portion from the standby position to a retreated position side.
(((5)))

The paper transport apparatus according to (((4))), further comprising:
a housing that receives a drive force from the drive unit in a state where the abutting portion is held,
wherein the positioning mechanism includes a locking piece that is automatically locked to the housing at the standby position and that releases a locked state in a case where the abutting portion starts to move.
(((6)))

The paper transport apparatus according to (((4))), further comprising:
a housing that receives a drive force from the drive unit in a state where the abutting portion is held,
wherein the positioning mechanism includes an electromagnet to which the housing is fixed at the standby position.
(((7)))

The paper transport apparatus according to any one of (((1))) to (((6))),
wherein the drive unit is configured to include a stepping motor, and
the release mechanism is a charge device that releases an excitation state of the stepping motor or a clutch that releases transmission of a rotational force of the stepping motor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper transport apparatus comprising:
an abutting portion against which a leading end of paper being transported is abutted and that corrects a slant of the paper;
a drive unit that includes a motor which reciprocates the abutting portion between a standby position where the abutting portion waits for the paper and a retreated position where the abutting portion is retreated from a transport path on a downstream side of the standby position in a transport direction; and
a release mechanism that releases transmission of a drive force from the motor to the abutting portion during movement of the abutting portion to the standby position.

2. The paper transport apparatus according to claim 1, further comprising:
an attenuation mechanism that attenuates movement of energy of the abutting portion to the standby position to stop the abutting portion after the release mechanism is operated.

3. The paper transport apparatus according to claim 2,
wherein the drive unit includes a gear, and
the attenuation mechanism includes an elastic body, and the abutting portion is biased to the downstream side in the transport direction in a state where the abutting portion is stationary at the standby position.

4. The paper transport apparatus according to claim 1, further comprising:
a positioning mechanism that regulates movement of the abutting portion from the standby position to a retreated position side.

5. The paper transport apparatus according to claim 4, further comprising:
a housing that receives a drive force from the drive unit in a state where the abutting portion is held,
wherein the positioning mechanism includes a locking piece that is automatically locked to the housing at the standby position and that releases a locked state in a case where the abutting portion starts to move.

6. The paper transport apparatus according to claim 4, further comprising:
a housing that receives a drive force from the drive unit in a state where the abutting portion is held,
wherein the positioning mechanism includes an electromagnet to which the housing is fixed at the standby position.

7. The paper transport apparatus according to claim 1,
wherein the drive unit is configured to include a stepping motor, and
the release mechanism is a charge device that releases an excitation state of the stepping motor or a clutch that releases transmission of a rotational force of the stepping motor.
